(19) United States
(12) Patent Application Publication
(10) Pub. No.: US 2007/0250452 A1
(43) Pub. Date: Oct. 25, 2007

(54) Apparatus for an automotive data control, acquisition and transfer system

(76) Inventors: Christopher Leigh, Tallahassee, FL (US); Matthew Chernosky, Tallahassee, FL (US); Herman Glenn, Sun Prairie, WI (US); William Howard, Tallahassee, FL (US); Stephen Pollock, Tallahassee, FL (US)

Correspondence Address: Ralph A. Dowell of DOWELL & DOWELL P.C., 2111 Eisenhower Ave, Suite 406, Alexandria, VA, 22314, US

(21) Appl. No.: 11/783,886

(22) Filed: Apr. 12, 2007

Related U.S. Application Data
(60) Provisional application No. 60/791,218, filed on Apr. 12, 2006.

(51) Int. Cl. G05B 19/00; H04Q 5/22; B67D 5/06; G08B 13/14; G06F 17/00

(52) U.S. Cl. 705/65; 340/572.1; 340/10.1; 340/5.9; 222/23; 235/375

(57) ABSTRACT

A system that controls, authorizes, and accounts fuel dispensed from fuel dispensers without the need for control and authorization input from individuals performing the fueling. The system comprises a radio frequency identification tag mounted on a fuel nozzle, an automotive information module mounted in the vehicle, a fuel island-mounted fuel management unit, and on-site or remotely-located software. The automotive information module interfaces with the vehicle's on-board computer system, the radio frequency identification tag, and the fuel management unit. With these interfaces, the automotive information module allows for autonomous creation and transfer of data and operational commands with in the disclosed system. The fuel management unit interfaces with the automotive information module, the fuel dispensers, and the software. With these interfaces, the fuel island-mounted fuel management unit provides autonomous fuel data processing. The software provides system owners, operators, and users raw data, analyzed data, and reports based on accumulated data from both the automotive information module and the fuel management unit.

### CROSS-REFERENCE TO RELATED APPLICATIONS

This application claims priority to U.S. provisional application No. 60/791,218, which was filed on Apr. 12, 2006, and entitled “Apparatus for an Automotive Data Control, Acquisition and Transfer System,” the subject matter of which is hereby incorporated by reference in its entirety.

### BACKGROUND OF THE INVENTION

1. Field of the Invention

The present invention is generally directed to fuel dispensing and autonomous automotive data collection and processing. Mores specifically, the present invention relates to the integration of a fuel dispensing and control system and autonomous automotive data collection into a single system that is suitable for both controlling, authorizing, and accounting fuel dispensed from fuel dispensers without requiring control and authorization input from individuals performing the fueling and for autonomous collection of automotive data.

2. Brief Discussion of the Related Art

Solid state microcontroller-based fuel control and accounting systems have been commercially available since the early 1980s. The known systems have incorporated many methods of accessing and transferring authorization data, including read-only electronic keys, read/write electronic keys, keypad entry, read-only radio frequency (“RF”) identification (“ID”) tags, read/write RF/ID tags, magnetic stripe cards, bar code readers and inductive coil antennae. Systems providing these means of data access are presently available from a large number of commercial companies.

Each of the known fuel control and accounting systems has disadvantages. The one common disadvantage of most of the systems is the inability to automatically positively identify a vehicle being fueled. Further, with regard to systems that require some operator input, the operator input can produce fuel control and accounting errors. To reduce the chance of operator error, many of the known systems utilize an inductive coil antennae pair. While the inductive coil antennae pair has reduced the chance of operator error, the antennae pair has generated a major disadvantage in the process. A system utilizing an inductive coil antennae pair requires a communication wire be affixed to a fueling hose so that communications can be accomplished via the inductive coil antennae pair mounted on a fuel nozzle and on a vehicle's filler neck.

Like the use of an inductive coil antennae pair, a system having RF/ID tags also has drawbacks. RF/ID tags can be categorized by numerous characteristics, including: short-range and long-range attributes, powered and non-powered attributes, and active and passive attributes. A powered RF/ID tag includes a battery or power source, and a non-powered RF/ID tag does not have a battery or other power source. The active and passive attributes are generally equated to an RF/ID Tag's interrogation response. A passive RF/ID tag will generally respond to interrogation with a specific code riding on a carrier wave which is based on an excitation wave. An active RF/ID tags is capable of responding on its own carrier wave and/or with its own coded signal and/or data. The coded signal and/or data can be variable detail and in much greater quantity than would be the specific code riding on a carrier wave transmitted by a basic passive RF/ID tag. As such, active RF/ID tags are usually powered and longer-range than passive tags. There are, however, powered passive tags where the powered feature is used only to increase the passive RF/ID tags' ranges.

Short-range RF/ID tags have very short-range operational characteristics that assure that only one RF/ID tag responds to a reader's interrogation. However, when long-range RF/ID tags are used for fueling, all RF/ID tags within range of a reader respond to that reader's interrogation. This response characteristic dictates that a secondary source of information is required in order to ascertain with which vehicle a long-range RF/ID tags is associated, which presents a major drawback to these fueling systems.

Further, systems having an onboard diagnostic bus (“OBD bus”) suffer from drawbacks. The OBD bus uses a defined protocol to transmit and retrieve information between a vehicle's on-board computers, which operate, monitor, and maintain the automobile. The OBD bus was mandated by the US government to provide a standardized way for automotive diagnostic tool manufactures to interface with, report malfunctions, and help diagnose problems in modern automobiles and trucks. These automotive diagnostic tools have access to this standardized OBD bus via a connector referred to as the OBD port. Currently diagnostic tools must be physically connected to an automotive diagnostic port in order to acquire information from the OBD bus. This usually occurs only after the vehicle has problems, and consequently preventative maintenance becomes difficult.

U.S. Pat. No. 4,263,945 to Van Ness discloses an automatic control system for dispensing fuel to vehicles. The system comprises a fuel control transmitter attached to a vehicle and a receiver unit attached to a fuel dispenser. However, this system provides no positive assurance that the dispenser's fuel nozzle is actually installed in the vehicle to which the fuel control transmitter is affixed. Also, no memory is provided in the receiver units, so each receiver unit must be on-line with a computer configured with logic and memory capabilities. Further, a receiver unit must be attached to each dispenser, and each receiver must be on-line with the computer.

U.S. Pat. No. 5,204,819 to Ryan discloses an apparatus for authorizing delivery of fuel to a vehicle from a fuel delivery device. The apparatus comprises a non-powered RF/ID tag associated with a vehicle, and a second device associated with the fuel delivery device which reads the RF/ID tag, authorizes, and controls fuel delivery. However, the system's non-powered RF/ID tag lacks the capability to directly monitor and accrue the vehicle's mileage. In order to monitor and accrue the vehicle's mileage, the vehicle would require an on-board computer configured for these tasks and for transferring of the accrued vehicle's mileage to the non-powered RF/ID tag for subsequent transfer to the second device.

Further, the second device's location on the fuel nozzle requires recharging of the second device's batteries, and/or electrical wires running along or in the fuel hose for a supply of the recharge power. The second device would be required to control the flow of fuel through direct valving in the nozzle, to monitor the quantity of fuel dispensed through a pulser mounted in the fuel nozzle, and to be intrinsically safe in accordance with requirements as defined for example by ANSI/UL 913. For the second device to be capable of RF communications with a remote location, further power would be required from this second device and this further burdens the technical feasibility of meeting the intrinsic safety driven power limitations of the second device.

U.S. Pat. No. 5,359,522 to Ryan discloses an apparatus for two-way communications between a vehicle and a fuel delivery device. The apparatus comprises a first two-way communications device associated with a fuel delivery device and a second two-way communications device associated with a vehicle. This apparatus has increased communicative abilities between the device on the vehicle and the device on the fuel delivery device relative to the system of U.S. Pat. No. 5,204,819, which has communication devices on a fuel nozzle and on a vehicle. However, the increased communicative disclosures further burden the technical feasibility of meeting intrinsic safety driven power limitations relative to the safety requirements as defined by ANSI/UL 913.

U.S. Pat. No. 5,923,572 to Pollock discloses an apparatus for system control, authorization, and accounting for liquid petroleum fuel dispensed from liquid petroleum fuel dispensers without the need for control and authorization input from individuals performing the fueling. The system comprises a RF/ID tag mounted on a fuel nozzle, an automotive information module mounted in a vehicle, a fuel island-mounted fuel management unit, and on-site or remotely-located software which provides the system owner with fuel usage and invoicing reports. However, this system does not include a true multifunctional two-way communication system, real autonomous operation with automotive information module initialization, control, and pass through of information to and from the vehicle's on-board computers, autonomous tuning of the automotive information module and RF/ID tag interface, and an automated process of defining and implementing a vehicle's scheduled and unscheduled maintenance requirements.

U.S. Pat. No. 6,618,362 to Terranova discloses a transponder that acts as a replacement for a wire connection at an OBD port. The transponder acts as a memory buffer facilitating information or message transfer between a remote communication system, such as a fuel dispenser, and the vehicle control system. Information written to the transponder memory from the fuel dispenser may be sent to or retrieved by the vehicle control system. Information sent to the transponder from the vehicle control system is made accessible by or transmitted to the fuel dispenser. The transponder includes sufficient communication electronics, memory access, and communication control circuitry and memory to allow storing of information and access to information by both the vehicle control system and the fuel dispenser.

However, the Terranova is system is unsatisfactory for at least two reasons. First, the Terranova system does not provide a pro-active vehicle maintenance system nor an autonomous fueling operation. In order to implement a truly autonomous preventative maintenance method and/or an autonomous fueling operation, an autonomous method of vehicle information download is required. Second, the Terranova patent fails to define uses for the disclosed transponder. These two short comings reduce the status of the disclosed transponder to that of an RF replacement for a piece of wire.

Thus, there is a need for a system which, when integrated into the multiplicity of technical data transfer requirements, eliminates the need for operator input and accordingly, eliminates operator error.

### SUMMARY

The automotive data control, acquisition and transfer system of the present invention provides both a fuel dispensing system in which all operator input to the fueling process is eliminated and an autonomous vehicle data collection method. When using the present system, an operator need only remove a fuel nozzle from a fuel dispenser, insert the nozzle into a filler neck of a vehicle's fuel tank, and dispense fuel. All fuel authorization and transaction data is autonomously collected and stored until transferred to software located on-site or at a remote location for processing into fueling reports and invoices. Vehicle maintenance data is also gathered autonomously during the fueling cycle and/or anytime the vehicle passes within an RF range of an RF transceiver which is integral with a fuel island mounted fuel management unit and/or integral to any unit mounted where a vehicle may commonly pass, such a parking lot entrance.

The fuel dispensing control, authorization, and accounting system comprises: a liquid and or gaseous petroleum fuel nozzle-mounted RF/ID tag, a vehicle-mounted automotive information module (“AIM”), a fuel management unit (“FMU”) installed at a fuel island of a fuel supply source, such as a gas station, and software loaded onto a computer at the fuel supply source or at a remote location.

The RF/ID tag is preferably mounted on each fuel dispenser nozzle of the fuel supply source. The RF/ID tag has a specific identification (“ID”) known by the fuel management unit and related to the fuel dispenser nozzle. Upon insertion of the fuel dispenser nozzle into a vehicle's fuel filler neck, the AIM reads the RF/ID tag on the nozzle. The RF/ID tag's specific ID, AIM stored data, including a vehicle ID, a fuel supply source signature (“site signature”), fuel types, quantity limits, and current vehicle mileage and/or hours are then transmitted by the AIM to the FMU via an AIM's RF transmitter. The FMU then correlates the received data with the FMU's internally-stored RF/ID tag and correlates fuel dispensing hose correlation data with the FMU's lock-in and lock-out data. If the data meets all acceptance criteria, then the FMU allows the fuel dispenser to dispense fuel.

The RF/ID tag can be a specially designed or a commercially available read-only or read-write short-range tag. The RF/ID tag's short-range is an important advantage with respect to overall system functionality, since the RF/ID tag is only within the range of a vehicle's AIM RF/ID tag antennae when the fuel nozzle is inserted into the vehicle's filler neck. In other words, fueling cannot occur unless the fuel nozzle is inserted into the vehicles filler neck so as to prevent unintentional or unauthorized dispensing of fuel. The RF/ID tag and the AIM antennae positional relationship also enables continuous security checking of the positional relationship, thereby allowing the FMU to terminate fueling once the nozzle is removed from the filler neck.

The AIM reads the RF/ID tag, transmits data, including RF/ID tag ID, vehicle specific data, and current vehicle mileage and/or hours, via RF transmission, and interfaces with the vehicle's on-board computers via an OBD Bus. The reading of RF/ID tags is accomplished via the AIM's microcontroller, RF/ID Tag interrogation circuitry and antennae. This reading is accomplished upon initial insertion of the nozzle into the filler neck and, after initial insertion, at continual intervals until the nozzle is removed. By this method, the AIM continuously monitors the presence of the RF/ID tag. Further, the AIM is capable of reading multiple RF/ID tags and, as a result, vehicles with multiple tanks can be refueled via multiple RF/ID tag equipped hoses.

The OBD Bus uses a defined protocol to transmit and retrieve information between a vehicle's on-board computers. These on-board computers are used to operate, monitor, and maintain the automobile. The OBD bus was mandated by the US government to provide a standardized way for automotive diagnostic tool manufactures to interface with, report malfunctions, and help diagnose problems in the modern automobile and truck. These automotive diagnostic tools have access to this standardized OBD bus via a connector referred to as the OBD port. The AIM connects to the OBD port to acquire the vehicle's mileage, acquire preventative maintenance data, and send commands to the vehicle's computers residing on the OBD bus.

An interface with the vehicle's speedometer/odometer and/or chronometer is accomplished by the AIM via the OBD port with newer vehicles. In non-OBD equipped vehicles, an interface is accomplished by directly monitoring the vehicle's electronic speedometer/odometer circuitry via a transducer in the vehicle's mechanical speedometer/odometer drive cable or via inclusion of and subsequent monitoring of an inductive pickup on the vehicle's drive shaft. The chronometer interface can be accomplished via monitoring of the vehicle's chronometer circuitry or via additional hardware built to supply said chronometer data.

The processing, logic, and management functions of the AIM are accomplished by an on-board microcontroller. The AIM's microcontroller provides for storage of the vehicle's fuel requirements and vehicle specific data, storage and processing of vehicle gathered data, such as data acquired via the vehicle's OBD port, execution of an active preventative maintenance program via data gathered via the vehicle's OBD port, processing of the data types for RF transmission, and the execution of programmable logic. The microcontroller allows the AIM to receive vehicle specific data from an external source, recognize a presence of a RF/ID tag and transmit data appropriate to the tag's presence or non-presence, and control the microcontroller's own startup and shutdown sequences.

The AIM uses bi-directional RF transmission to transfer data, including RF/ID tag specific data, vehicle and fuel requirements specific data, and OBD port gathered vehicle specific data, to the FMU. An FMU's microcontroller compares the received fueling specific data and RF/ID tag data with the FMU's stored lock-in and lock-out data lists so that authorization of fuel delivery can be undertaken. Data received from the vehicle's computers via the OBD port and then the AIM is also processed by the FMU and transferred to a control and data transfer software program for use in an active or passive preventative maintenance program.

The FMU authorizes fueling operations via direct control of non-electronic fuel dispensers or via serial or other industry standard communications with electronic fuel dispensers. Upon fueling authorization, the FMU monitors fueling operations for pulse count, which equates to fuel quantity dispensed, and fueling completion. Upon the fueling completion or upon reaching maximum quantity limits, the FMU terminates the fueling operation via control over the fuel dispensers and records a transaction. The transaction includes at least the following information: data received via RF transmission from the AIM, fuel quantity information acquired from pulses equating to fuel quantity dispensed or acquired directly via a serial connection to an electronic dispenser, and the FMU configured data including a time, date, fuel type, and hose number.

In light of the structure of the automotive data control, acquisition, and transfer system of the present invention, it is an object of the invention to provide a liquid fuel delivery system which denies the issuance of fuel if a liquid fuel nozzle is not within a receiving range of available short-range communications and data transfer devices. It is a further object to provide a system for determining whether a vehicle receives fuel by verifying data from an RF/ID tag on a fuel nozzle, AIM specific data, and FMU stored data. These two features of the present invention thereby alleviate the two most common fuel control and accounting system errors, namely human error and theft.

It is yet another feature of the present invention to provide a liquid fuel delivery system having means to reduce the required operator input. By reducing an operator's training and educational requirements, the costs associated with fuel control and accounting are reduced.

It is yet another feature of the invention to provide a system adaptable to all forms of substance transfer. The present system can be used for dispensing all forms of liquids, gases, and solids dispensed via a hose, chute, and/or nozzle.

It is yet another feature of the invention to provide for the incorporation of both a site dependent and hose dependent digital code encrypted into the AIM and the RF/ID tag, respectively. Via means of fuel authorization of the present system, RF conflicts and data conflicts between hoses, sites, and transactions are eliminated, thereby eliminating potential errors which could otherwise occur when multiple fueling operations are occurring simultaneously at different hoses located at either the same or different fueling sites within the RF reception range of a given RF transceiver set.

It is yet another feature of the present invention to provide for the incorporation of a powerful microcontroller-based computer into the FMU to allow the system to interface with future technologies, such as 2-D bar coding, advanced versions of RF/ID tags, and governmental requirements for technical implementations of standards, as they become commercially available in the near future. Due to the system's flexibility, these products and technical implementations of standards can be instituted within the capabilities of the invention.

It is yet another feature of the invention to provide for the enhancement of existing fuel control and accounting systems. Existing systems have positive features which are responsible for their widespread acceptance and use. These positive features include: providing security at a fueling site without requiring an on-site attendant, accurately monitoring the use of fuel, issuing reports for fuel usage, and issuing invoices for the use of fuel. The known systems have had problems associated with operator input errors and fuel theft by individuals with authorized access to a fueling site. The disclosed system can be installed in new or existing fuel control and accounting systems to eliminates input errors and theft at existing sites. In addition, due to customer familiarity with existing systems, there exists the potential for customer reluctance to purchase new and different fuel control and accounting systems. The present system's enhancements over existing systems serve to mitigate potential customer reluctance.

It is yet another feature of the invention to provide a system capable of minimizing equipment installation time. The AIM of the present system collects all required information from computers on-board a vehicle's OBD bus and from an FMU via bi-directional RF communications. With the AIM's “smart on-board microprocessor/microcontroller,” to install and initialize the AIM, the system only requires that the AIM be physically installed in a vehicle, the vehicle be driven within range of an FMU's RF transceiver, and the FMU be instructed to set up the AIM's authorized products and electronic signature. The AIM can then obtain all needed initialization data from the vehicle's computers on the OBD bus and the FMU.

It is yet another feature of the present invention to provide a system of autonomous and active preventative maintenance. Since the system's AIM interfaces with computers on-board a vehicle's OBD bus, has bi-directional RF communication capability with the FMU, and has a “smart on-board microprocessor/microcontroller”, the AIM actively collects vehicle information data and will autonomously pass this along to the FMU and subsequently to onsite or remotely-located software. The on-site or remotely-located software then exports the data to fleet maintenance software programs. Since the passed along data is both timely and accurate, fleet vehicle maintenance costs will decrease. The AIM is also capable of requesting that the vehicle's on-board computer display information on the vehicle's dash. For example, the check engine light could be turned on to prompt the drive to return the vehicle for maintenance.

It is yet another feature of the present invention to provide a system which minimizes RF air time, thereby maximizing communication efficiency. The AIM's “smart on-board microprocessor/microcontroller,” the OBD bus interface, and bi-directional RF communication capability enable communication efficiency to be maximized. The FMU controls the amount of RF air time using the bi-directional RF communication capability of the system. Each AIM only broadcasts in response to a request from the FMU, and the FMU may request only the specific data which it requires from the AIM. Via this method, only one AIM communicates at a time. In a system without bi-directional RF communication capability, each AIM needs to constantly broadcast all of its available information, such as vehicle information, current mileage, preventative maintenance information, etc., because the FMU does not communicate to the AIM which information the FMU requires and whether the FMU has received it correctly. The constant broadcast uses much more air time and increases interference between modules. Similarly, in a system using simple transponders, the FMU needs to ask a series of questions of each AIM, and each AIM would respond to each question in turn. As a result, much more air time is used with increased interference.

It is yet another feature of the invention to provide a system capable of autonomous updates. In the firmware of the present system, updates and feature selections to both the FMUs and AIMs are performed from the on-site or remotely-located software, as a result of the internal update firmware of both the FMU and AIM and of the bi-directional RF communication capability of the FMU and AIM.

It is yet another feature of the invention to provide a system capable of autonomous tuning of a filler neck antenna loop and of a nozzle mounted RF/ID tag antenna interface. The tuning of an antenna is controlled by inductance/capacitance (L/C) characteristics of the antenna. The metal in a vehicle acts to change the L/C characteristics of antennae circuits, which can cause each antennae installation to be custom tuned. The microprocessor/microcontroller and circuit specific components of the present system allow the AIM to autonomously tune every installation without the need for installer's or technician's assistances or the need for parts and circuits specifically tuned for each vehicle and installation. Functionality is optimized and therefore inventory and installation man-hours are reduced. Further, the installation becomes a “plug and play” scenario.

It is yet another feature of the present invention to provide a system capable of selecting a frequency with a highest signal to noise ratio. The FMUs look for the quietest frequency on which to communicate with the AIMs. The AIMs look for the frequency on which the FMU is transmitting. Further, if an AIM changes to the transmission frequency of an FMU which is different from the FMU controlling the hose selected by the user, the AIM again searches frequencies until it finds the correct FMU.

It is yet another feature of the invention to provide a priority system for messages exchanged between the FMU and the AIM. As a result of the system's FMU's microprocessor/microcontroller control and bi-directional RF communication capability, messages necessary for control of primary system functions, such as fueling, are requested and transmitted more often than messages which are associated with secondary systems functions, such as preventative maintenance or firmware update.

It is yet another feature of the invention to provide an AIM that is equipped with a powerfail data save capability. Via this capability and the accompanying circuitry, the AIM is able to detect an impending powerfail and then store data, such as active operating instructions and in process data, to non-volatile memory before power is lost so that the data and operation associated therewith may be continued when power is restored. The active operating instructions and in process data include: current odometer and/or chronometers data, speed sensor pulse count, and any firmware update progresses. Further, the AIM's powerfail data save capability provides many benefits. For example, the AIM may be removed from the vehicle at any time. Also, no data, such as odometer and chronometer data, is ever lost, and the AIM is able to retain data during low voltage conditions which may occur during normal operation, such as during starting of the vehicle. In addition, no internal battery is required.

It is yet another feature of the present invention to provide an AIM's “smart on-board microprocessor/microcontroller” that is capable of communications with and receiving data from a global positioning system (GPS) receiver. Additionally, upon receipt of the GPS data, the AIM's “smart on-board microprocessor/microcontroller” is then able to process the data into vehicle tracking information, such as a maximum vehicle speed and where the speed occurred, a longest period of time when the vehicle was at rest both with and without the motor running and where the period of time occurred, etc.

It is yet another feature of the present invention to provide a system with AIMs having means for AIM to AIM direct communication. Direct AIM to AIM communication provides an autonomous method of retrieving information from AIM equipped vehicles that do not regularly drive within range of an FMU, such as road service vehicles, including tractors for roadside mowing, mine vehicles, and non-highway use construction equipment. The AIM is capable of autonomous updates, whereby firmware updates and feature selections for the AIM is performed from the on-site or remotely-located software. This capability allows the on-site or remotely-located software operator to specify and direct a specific vehicle's AIM or multiple vehicles' AIMs to communicate with other specific vehicles for the purpose of gathering information and transferring the information to an FMU when the gathering vehicle comes within RF range of the FMU.

It is yet another feature of the present invention to provide a fuel system having an AIM that is equipped with an auxiliary communications port. An auxiliary serial port allows an AIM's communications and features capability to be expanded to meet future and customer specific needs and interfaces. For example, police cars, emergency vehicles, fire trucks, and school buses are equipped with a multitude of job specific electronic equipment. Via the AIM's auxiliary serial port, future and customer specific interfaces can be accommodated.

It is yet another feature of the invention to provide a system with an AIM that autonomously activate a gate and/or provide entrance security. The disclosed system targets the fuel industry and as such, the remote R/F communication system is located in a fuel island mounted FMU, which controls the dispensers and communicates with the on-site or remotely-located software. However, in addition to being located in an FMU or at a fuel site, the remote R/F communication system can be mounted near a gate, a yard entry point, a maintenance facility, or parking area. By installing the remote R/F communication systems near entrances and facilities, fleet operators are able to track and locate vehicles other than when they are fueling. In addition, as the disclosed system is able to activate fuel dispensers, the present system is also able to activate security gates.

It is a further object of the invention to provide a system with an AIM that autonomously acquires vehicle data for use in fleet management programs. The AIM's R/F communication system can be attached to or located in a handheld portable computer, such as a personal digital assistant (PDA). The R/F communication system equipped PDA can be used to interrogate AIM equipped vehicles to acquire vehicle data for use in fleet maintenance programs. In addition, there are a number of additional features that can be accomplished with an R/F communication system equipped PDA. A maintenance procedure can be loaded on the PDA so that maintenance personnel see the vehicle's deficiencies as acquired via the AIM and the vehicle's OBD connection on the PDA's LCD. Maintenance personnel can also see the procedures to correct vehicle deficiencies on the PDA's LCD.

It is yet another feature of the invention to provide a system having an AIM that tracks and records power take-off (PTO) engine run time and then transfers the data to the on-site or remotely-located software. The on-site or remotely-located software then analyzes the PTO data to provide taxable and non-taxable fuel usage data for vehicles which use highways. When AIMs are placed on vehicles, which are considered off-road only vehicles, the on-site or remotely-located software can also be used to separate this non-taxable fuel from taxable fuel used on over the road vehicles.

It is yet another object of the present invention to provide a system having an AIM that acts as an autonomous credit card and an FMU that authorizes and processes the autonomous transaction though commercial banking networks. The system includes means to load and store commercial credit card numbers and/or appropriation authorization data in an AIM or an FMU. This data is then used by the FMU to authorize a transaction and to process the transaction data though commercial banking networks. As a result, a fueling transaction becomes an autonomous operation, whereby a user simply gets fuel and his or her credit card gets charged for the transaction.

### BRIEF DESCRIPTION OF THE DRAWINGS

A better understanding of the invention will be had with reference to the attached drawings, wherein:

FIG. 1 depicts a fuel nozzle with an RF/ID Tag affixed in the fuel nozzle's splash guard and a loop antennae having an element of an automotive information module's RF/ID tag interrogation circuitry attached around the vehicle's fuel tank filler neck;

FIG. 2 depicts a vehicle with an installed automotive information module (AIM), a fuel dispenser, and a fuel island-mounted fuel management unit (FMU) in accordance with the invention;

FIG. 3 is a flow diagram illustrating the interconnection and the flow of control and data within an RF/ID tag in accordance with the invention;

FIG. 4 is a flow diagram illustrating the interconnection and the flow of control and data within a single hose mechanical fuel dispenser containing both an internal pump and an associated motor;

FIG. 5 is a flow diagram illustrating the interconnection and the flow of control and data within a single hose electronic fuel dispenser containing both an internal pump and an associated motor;

FIG. 6 is a flow diagram illustrating the interconnections and the flow of control and data within an AIM in accordance with the invention; and

FIG. 7 is a flow diagram illustrating the interconnections and the flow of control and data within a fuel island-mounted FMU in accordance with the invention.

### DETAILED DESCRIPTION OF THE PREFERRED EMBODIMENT

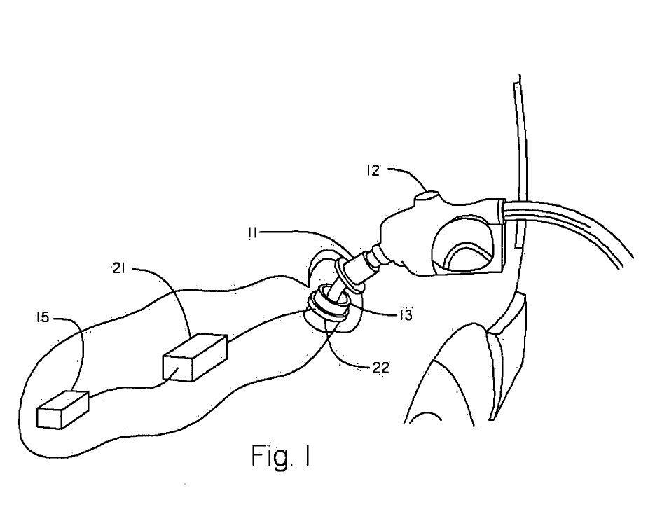

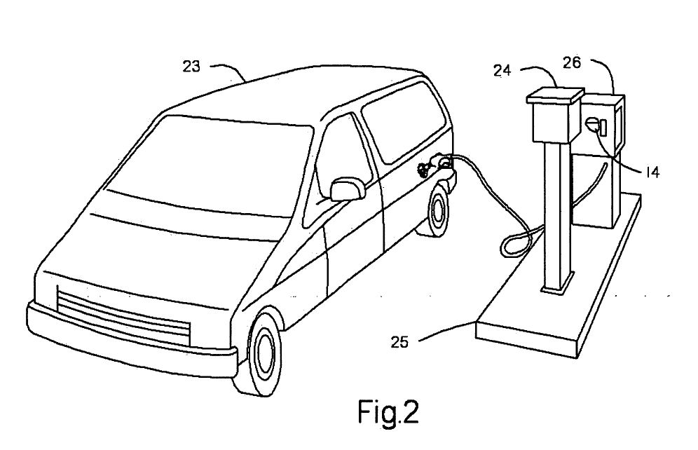

Referring to FIGS. 1 and 2, the automotive data control, acquisition and transfer system of the present invention comprises an RF/ID tag 11 which is preferably molded into a splash guard of a liquid fuel nozzle 12, and a microcontroller-based automotive information module (“AIM”) 21 mounted within a vehicle 23. The AIM 21 includes an associated loop antenna 22 which is preferably mounted around fuel filler neck 13, an associated onboard diagnostic bus (“OBD bus”), and an OBD bus connector 15. “OBD bus” is used to refer to any of federal and industry diagnostic bus standards, including the OBD II, J1708 and J1939 bus standards. The system also comprises a fuel management unit (“FMU”) 24, which is preferably mounted on fuel island 25 having fuel dispenser 26 with a reset handle 14. Alternatively, the fuel island 25 can include a plurality of fuel dispensers with a plurality of fuel hoses per fuel dispenser provided at a fuel supply source.

The system further comprises a computer having configuration and reporting software that is compatible with the AIM 21 and FMU 24. The computer is preferably an IBM PC. Further, the computer can be located on site at a fuel supply source, such as a gas station, or at a remote location.

To install the system, each vehicle 23 is equipped with an AIM 21, and a fuel island 25 is equipped with an FMU. Further, each fuel nozzle 12 on the fuel island 25 is equipped with an RF/ID tag 11. Configuration and reporting software is then loaded onto the computer, which is located on-site or at a remote location.

The AIM 21 is configured with a fueling site signature, a vehicle identification (“ID”), a fuel type, fuel quantity limits, an initial odometer reading, and other pertinent information. The FMU 24 is configured with the fueling site signature, an RF/ID tag ID to fuel hose correlation, lock-in and lock-out lists, and other pertinent information. Lastly, all databases are properly built within the configuration and reporting software of the computer, and the software is in communication with the FMU 24 to enable to FMU to download lock-in and lock-out lists and upload fuel transaction lists.

Once the system is installed, it is ready to be used in operation. In operation, an operator removes the fuel nozzle 12 from the fuel dispenser 26 and moves the fuel dispenser's reset handle 14 to a fueling position. The operator then inserts the fuel nozzle 12 into the filler neck 13 of a vehicle's fuel tank. Alternatively, via RF bi-directional communication between the RF/ID tag 11 on the fuel nozzle 21 and the antenna 22 of the AIM 21, the antenna 22 can read or interrogate the RF/ID tag 11 so that dispensing fuel may be an autonomous result of removing the fuel nozzle 12 from the fuel dispenser 26. Thus, the reset handle 14 need not be moved to the fuel position for fuel to be dispensed from the fuel dispenser 26.

The system then transfers the data from the RF/ID tag 11 and vehicle related data from the AIM 21 to the FMU 24. Vehicle related data includes data stored within an internal memory of the AIM 21, as well as data retrieved from the vehicle's OBD bus via the OBD bus connector 15. Alternatively, the vehicle related data transfer need not be associated with a fuel operation, but rather can be accomplished autonomously any time the vehicle 23 is within RF range of the FMU 24. During normal vehicle operation and when the AIM 21 first enters RF range of FMU 24, the AIM 21 combines vehicle specific data stored in the AIM's internal memory, fueling supply source specific data, the current vehicle mileage and/or chronometer data, and error detection data and transmits the data to FMU 24.

If the transferred data is correct, then the FMU 24 automatically authorizes a fueling sequence by allowing the fuel dispenser 26 to be activated. The FMU 24 monitors and records the fueling sequence as a fuel transaction. The FMU 24 then transfers the fuel transaction data to the configuration and reporting software of the computer for further processing, including record keeping and invoice processing.

In addition, during normal vehicle operation, the AIM 21 continuously records vehicle miles as accrued. The accrued mileage is sometimes measured, as is the case with vehicles with analog speed sensors, sometimes calculated from OBD data, and sometimes monitored, as is the case with the OBD protocols.

The AIM 21 also includes RF/ID tag interrogation circuitry. The RF/ID tag interrogation circuitry is only activated when the AIM 21 is within RF range of FMU 24 and when the vehicle 23 is stopped. By not activating the RF/ID circuitry every time the vehicle 23 stops, the system saves power. Further, the AIM 21 is also able to check that the vehicle's engine is not running before activating the circuitry.

If the AIM 21 does not detect an RF/ID tag 11 after a configurable finite period of time, then the AIM 21 goes into sleep mode and stops acknowledging the FMU 24. After the configurable finite period of time has expired, the RF/ID circuitry can be reactivated by reactivating the vehicle OBD bus, such as by cycling of the vehicle's power, which causes the AIM 21 to re-initiate vehicle mileage tracking and/or RF/ID tag 11 interrogation sequence.

If the AIM 21 does detect an RF/ID tag 11, then the AIM 21 transmits a “hose inserted” message, including a nozzle tag number, to the FMU 24. The AIM 21 continues to transmit the “hose inserted” message to the FMU 24 until the FMU 24 makes an acknowledgement. Also, the AIM 21 will continue to interrogate the RF/ID tag 11. If an RF/ID tag 11 is not detected after a finite period of time, then the AIM 21 will terminate both searching for and transmitting acknowledgment of, an RF/ID tag's presence, and the AIM 21 will send a “terminate fueling” message to FMU 24.

During normal operations, using RF transceiver circuitry, the FMU 24 initiates a series of communication commands. For example, the FMU 24 sends a command to each individual AIM 21 to make sure that a vehicle 23 is still present. The FMU 24 also sends a command to have all AIMs 21 that have not been recognized by FMU 24 to respond. Also, the FMU 24 sends a command requesting that every AIM 21 requesting fuel to respond with fueling request data. Via these commands, the FMU 24 is able to track all AIMs 21 within its RF transceiver's range. The FMU 24 can also communicate with each AIM 21 determine if firmware updates are needed, determine if vehicle specific data needs to be gathered via the vehicle's OBD bus port 15, send messages to either the AIM 21 or the vehicle's onboard computer via the vehicle's OBD bus port 15, and initiate the exchange of data based on the prior queries.

In the automotive data control, acquisition, and transfer system, the FMU 24 and the AIM 21 conduct three major categories of data transfer: updating the firmware code of the AIM 21, fueling operations, and transfer of vehicle specific data obtained via the OBD port 15. With regard to transferring data for fueling operations, upon receiving a transmission from the AIM 21, the FMU 24 checks the received data against the FMU's internally-stored data, including fueling site signature, vehicle lock-out and lock-in data lists, RF/ID tag 11 to fuel dispensing hose number correlation list, and allowable fuel data.

If all selection criteria are correct and the FMU 24 is wired to control the dispenser 26 directly, as would be the case for a mechanical dispenser, then the FMU 24 checks that the reset handle 14 is turned on, initiates a transaction, turns on the appropriate fuel dispenser hose, counts pulses equating to a fuel quantity dispensed, and monitors RF reception for continuing data from the AIM 21 indicating that the nozzle 12 is still inserted into the vehicle's filler neck 13.

If all selection criteria are correct and the FMU 24 is wired to control the dispenser 26 via a serial data line, as would be the case for an electronic dispenser, then, via a serial connection, the FMU 24 instructs the dispenser 26 to dispense fuel and to monitor the quantity. When the nozzle 12 is removed from the filler neck 13, the AIM 21 sends a “terminate transaction” message to the FMU 24, whereby the FMU 24, via its serial control, instructs the dispenser 26 to terminate the transaction and to send the fuel quantity data to the FMU 24.

If all selection criteria are not correct, no fuel is dispensed. The FMU 24 terminates a fueling sequence upon a failure to receive the continuing data from the AIM 21, receiving a “hose removed” message from the AIM 21, the internally programmed FMU 24 timers reaching programmed limits, and/or the pumped fuel quantity reaching quantity limits defined by the vehicle's data string. Upon termination of the fueling sequence, the FMU 24 logs a transaction record within its memory.

If the FMU 24 determines that the AIM 21 software code and/or data needs updating, then the FMU 24 sends a new code and/or data to the AIM 21, whereby the AIM 21 does an internal update. Further, the FMU can send the new code and/or data over multiple sessions. The AIM 21 then stores the new code and/or data and is able to process the new code and/or data once the complete information has been successful transferred.

The FMU 24 is capable of two-way communication with the AIM 21, whereby the AIM 21 returns internally stored or vehicle specific data obtained on demand via the vehicle's OBD bus port 15 to the FMU 24. The data may have been gathered by the AIM 21 autonomously or when requested by the FMU 24. Additionally, both the FMU 24 and the AIM 21 can use their communications capabilities to have the vehicle's computers display information on the vehicle's instrument panel.

Additionally, the FMU 24 can, independently of and/or concurrently with the fueling operations, communicate with other FMUs, called “satellite FMUs, as well as communicate with remotely-located software. Communications with the software include a fuel transaction data transfer to the software for purposes of accounting, processing, and invoicing, and a transfer of updated lock-out and lock-in data to the FMU 24.

Thus, operation of the aforementioned system is autonomous and conducted without participation by individuals using fuel facilities.

There are numerous types and variations of commercial mechanical and electronic fuel dispensers 26 currently available, and the FMU 24 is configured to interface with different types and variations of dispensers 26. If a dispenser 26 only includes a motor, then the FMU 24 controls the motor directly. Similarly, if a dispenser 29 includes a motor and a motor controller, then the FMU 24 controls the motor controller.

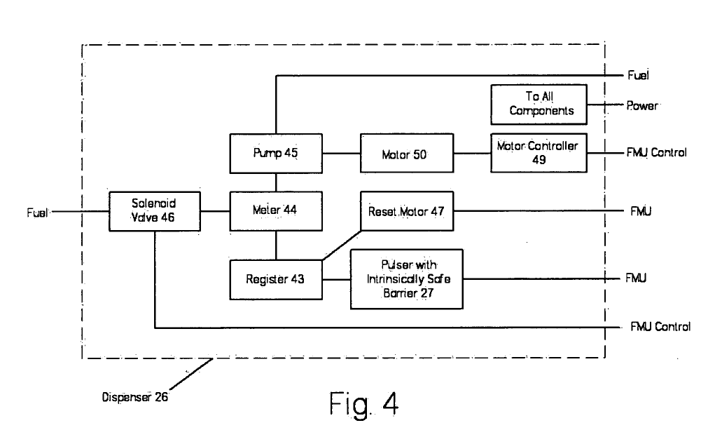

FIG. 4 depicts a mechanical dispenser 26 having motor controller 49, which controls a motor 50, which in turn drives a pump 45. The pump 45 drives fuel through a meter 44 via a solenoid valve 46 and to the fuel nozzle 12. A register 43 displays the amount of fuel that passes through meter 44 and turns a pulser 18 so that the pulser's output is proportional to the fuel passing through meter 44. Upon power application to the motor controller 49 and the motor 50, indirectly or directly, a reset motor 47 sets the register 43 to zero and allows the motor 50 or the solenoid valve 46 to be activated, thereby allowing dispensing of fuel. Within the mechanics of the reset motor 47 is a reset handle such as reset handle 14. The FMU 24 is capable of monitoring the reset handle's position to determine fueling completion, and the FMU 24 controls solenoid valve 46.

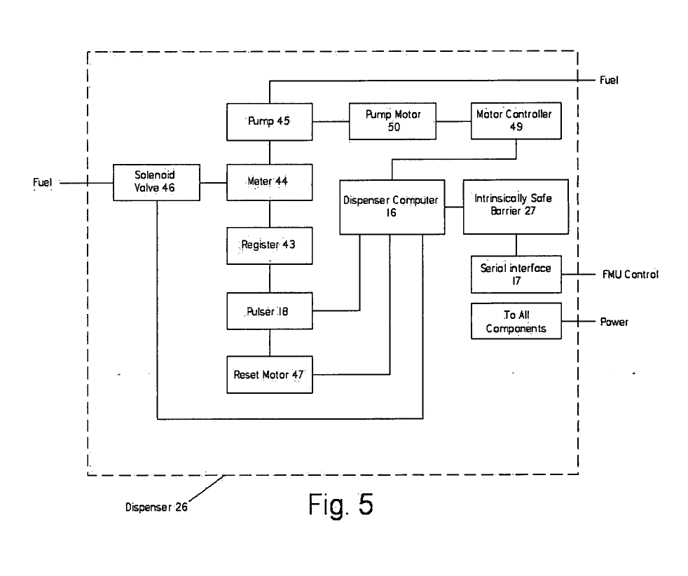

An electronic fuel dispenser 26 is shown in FIG. 5. An electronic fuel dispenser includes a microcontroller-based control unit 16. The FMU 24 is configurable to communicate serially with the fuel dispenser's microcontroller to thereby eliminate the need for the FMU 24 to directly control the dispenser's motor controller and/or valve or to monitor and count pulses. These functions in the electronic dispenser 26 are controlled by the dispenser's microcontroller-based control unit. The FMU 24 can exercise control over and acquired data from an electronic dispenser 26 via the serial port connection.

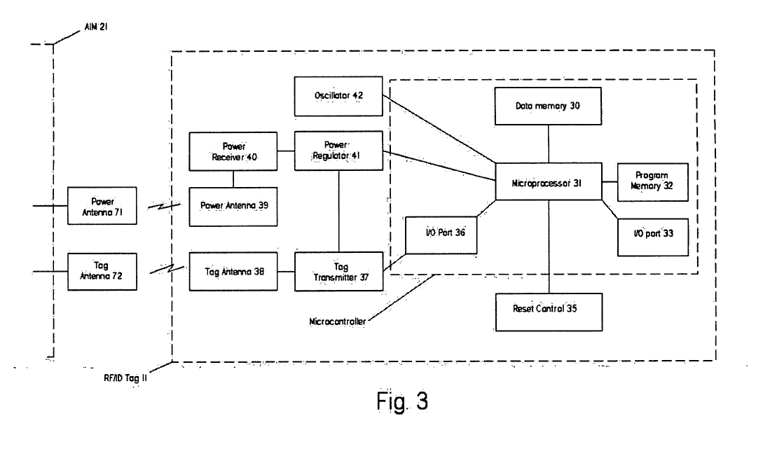

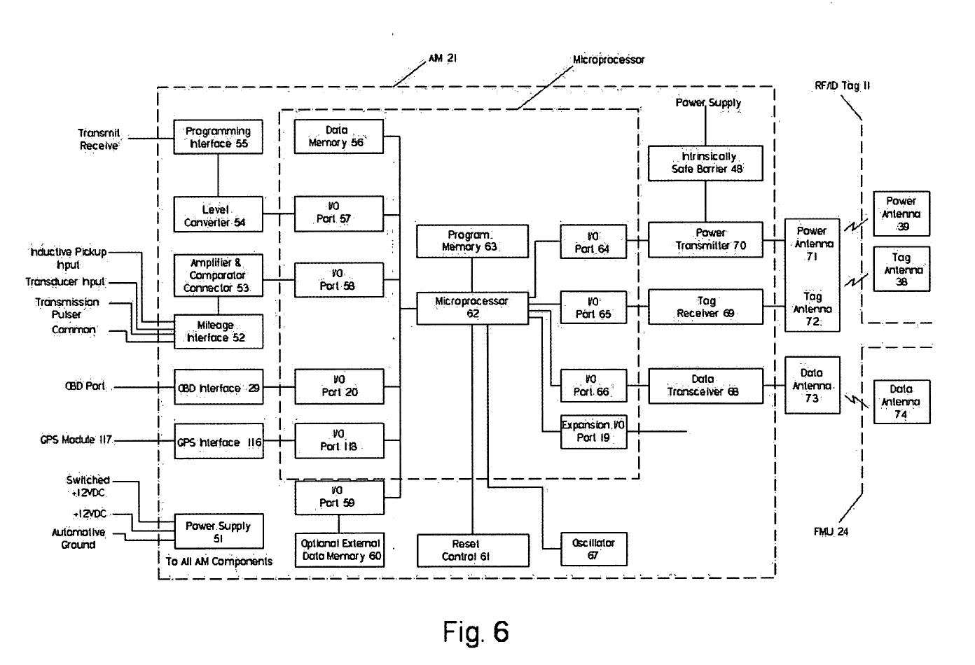

As per the aforementioned discussion on RF/ID tags, the complexity and capabilities of an RF/ID tag range from a very basic non-powered RF/ID tag to a complex powered RF/ID tag. The very basic non-powered basic tags can be comprised of as little as a simple state-machine and a tuned antenna. Whereas the more complex powered RF/ID tags can be comprised of a PC, a transceiver and a power supply. The distinguishing feature of all RF/ID tags is that when queried they respond with data. The disclosed system is compatible with all types. Although any on the RF/ID Tags can be sued by the disclosed system, FIG. 3 represents a middle of-the-road design. The microprocessor/microcontroller 31 based RF/ID Tag 11 in accordance with the disclosed system incorporates receiver circuitry, transmitter circuitry, and program logic into nozzle 12 mounted package resembling and potentially substituting for a fuel nozzle's splash guard. The receiver circuitry comprises power antenna 39, power receiver 40 and power regulator 41. The transmitter circuitry comprises tag antenna 38, tag transmitter 37 and I/O port 36. The program logic comprises data memory 30, program memory 32, reset control 35, oscillator 42 and I/O port 33. RF/ID Tag 11 operates as follows. Power regulator 41 circuitry absorbs RF energy transmitted by AIM 21. The RF energy is received via power antenna 39 and power receiver 40. When the absorbed energy reaches a predetermined value, voltage is applied to microprocessor/microcontroller 31, wherein microprocessor/microcontroller 31 executes a short program received from program memory 32. The short program includes the transmission of the interrogation data via tag transmitter 37 and tag antenna 38. As long as the RF energy is sufficient, the microprocessor/microcontroller 31 repeats this. Once the RF energy is gone, microprocessor/microcontroller 31 has no power source and turns off. Referring to FIG. 6, microprocessor/microcontroller 62 based AIM 21 in accordance with the disclosed system incorporates RF transmitter/receiver circuitry, vehicle interface circuitry, and program logic into a vehicle-mounted package. The RF transmitter/receiver circuitry comprises power antenna 71, tag antenna 72, data antenna 73, power transmitter 70, tag receiver 69, data transmitter 68, associated I/O ports 64, 65, 66, and intrinsically safe barrier 48. Safety requirements in and around fuel areas are driven by NFPA requirements (National Fire Protection Association) and the intrinsically safe barrier complies with these requirements. The NFPA's intrinsic safety requirements are defined by ANSI/UL 913 (Underwriters Laboratories, Inc.). The vehicle interface circuitry comprises mileage interface 52 and associated amplifier and comparator 53 and I/O port 58, and power supply 51. The program logic comprises data memory 56, program memory 63, reset control 61, oscillator 67, optional external data memory 60 and associated I/O port 59, and programming interface 55 having an associated level converter 54 and I/O port 57.

When AIM 21 is installed on a vehicle without an OBD port, AIM 21 operates as follows. Power supply 51 receives power from the vehicle, and converts and distributes the power to all required AIM 21 components. Mileage interface 52 monitors vehicle mileage. The vehicle mileage is monitored via a sine wave or a pulse count passed through amplifier and comparator 53 to I/O port 58 and to microprocessor/microcontroller 62. Microprocessor/microcontroller 62 counts pulses (a sine wave input is converted to pulses by the amplifier and comparator 53), adds same to the existing mileage count, and then stores the new mileage count in data memory 56. This mileage update process is carried on continuously as the vehicle generates mileage pulses as it moves.

When AIM 21 is installed on a vehicle with an OBD port, AIM 21 operates as follows. The power supply 51 receives power from the vehicle, and converts and distributes the power to all required AIM 21 components. The AIM's 21 OBD interface 29 hardware is connected to the vehicle's OBD port. AIM 21 can then acquire vehicle specific data from vehicle computer on the vehicle's OBD bus. Included in this data is the vehicle's mileage and speed information.

Programming interface 55 allows an external computer (for example, an IBM PC computer, laptop or notebook based computer) to initialize and input vehicle specific data. The data includes, for example, fueling site ID, vehicle ID, fuel type and quantity limitations, initial mileage and pulse count to mileage conversion, and is stored in the microprocessor's on-chip data memory 60. Programming interface 55 transfers data to and from microprocessor/microcontroller 62 via I/O port 57 and level converter 54. Microprocessor/microcontroller 62 contains unused I/O Port 19 for future expansion and interfaces to items such as a Prokee®s, magnetic strip card readers, RF/ID tag readers, etc.

AIM 21 includes four communications means: power transmission to RF/ID Tag 11, reception of RF/ID Tag ID information from RF/ID Tag 11, two-way RF communication of RF/ID Tag ID and vehicle specific data to FMU 24 and serial communication with the vehicle's computers residing on the vehicle's OBD bus.

Power transmission to RF/ID Tag 11 is via microprocessor/microcontroller 62 sending a transmit signal via associated I/O port 64 to power transmitter 70 and to the power antenna 71. The power antenna 70 is driven by the intrinsically safe barrier 48. The program logic for sending the transmit signal originates in the program memory 63. The program logic looks for the pulse count to stop, due to the vehicle stopping, and a programmable time period to elapse, or the vehicle's ignition to be turned off. The program logic discontinues the transmit signal upon removal of nozzle 12 from filler neck 13, or after a programmable time period elapses without the reception of RF/ID Tag 11 data.

The reception of RF/ID Tag ID information from RF/ID Tag 11 is accomplished via microprocessor/microcontroller 62 receiving data via associated I/O port 65 from tag receiver 69 and tag antenna 73. Upon reception and successful error checking, the RF/ID tag data is stored in data memory 56, and AIM 21 proceeds with its third RF communications means, transmission of RF/ID Tag ID information and vehicle specific data to FMU 24.

The transmission of RF/ID Tag ID information and vehicle specific data to FMU 24 is via microprocessor/microcontroller 62 receiving vehicle specific data (for example, site ID, vehicle ID, fuel type and quantity limitations, and current mileage) and RF/ID Tag ID information from the data memory 56 and sending same to data antenna 73 via data transmitter 68 and I/O port 66. The transmission of data by data antenna 73 is also programmable with respect to the speed, frequency of transmissions, and number of repetitions.

Microprocessor/microcontroller 62 via program memory 63 is programmed to continue interrogating RF/ID Tag 11 via the power transmission circuitry and the reception of RF/ID Tag ID circuitry, and if RF/ID Tag 11 does not respond to the interrogation, microprocessor/microcontroller 62 initiates the transmission of a discontinue fueling code to FMU 24 to ensure that fueling is discontinued if fuel nozzle 12 is removed from the vehicle's filler neck 13.

Microprocessor/microcontroller 62 via I/O Port 118 and GPS Interface 116 is in communications with GPS Module 117. Via this communications microprocessor/microcontroller 62 has access to global positioning information which can be related to data received from the vehicle's on-board computers via the vehicle's OBD Port, OBD Port 29 and I/O Port 20. Access to both the global positioning information and the data received from the vehicle's on-board computers by computers running the on-site or remotely-located software allows for generation of data and reports which link vehicle data to global position.

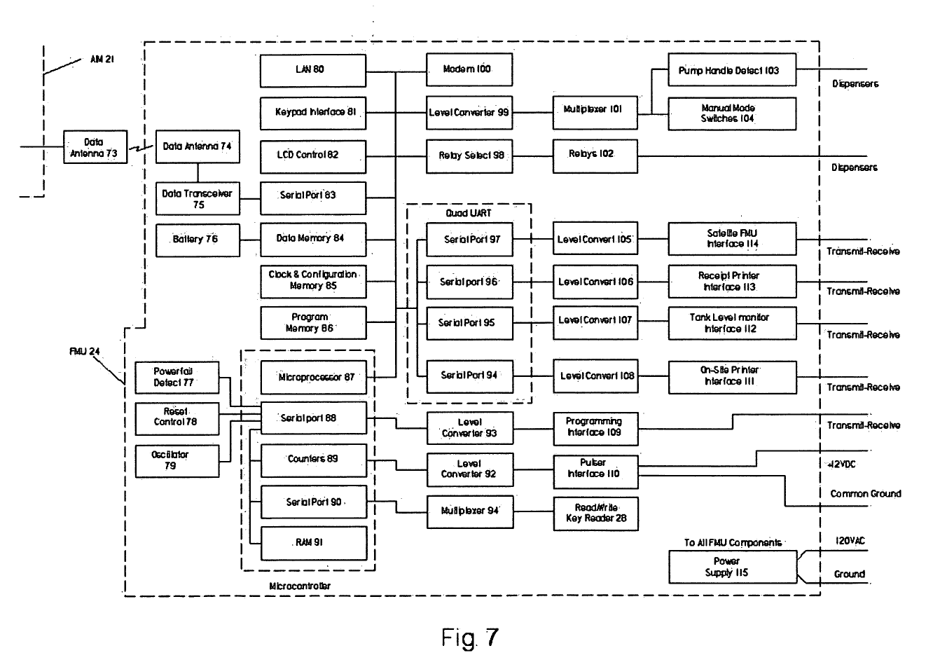

Referring to FIG. 7, Microprocessor/microcontroller 87 based FMU 24 incorporates RF receiver circuitry, fuel dispenser interface circuitry, operator interface circuitry, peripheral equipment interface circuitry, and a remote communications interface and program logic, into Fuel Island 24 mounted package.

The RF transmitter/receiver circuitry comprises data antenna 74, data transceiver 68, data antenna 73 and serial port 66.

The fuel dispenser interface circuitry comprises pulser interface 110, level converter 92, counters 89, pump handle detect 103, manual mode switches 104, multiplexer 101, level converter 99, relays 102 and relay select 98.

The operator interface circuitry comprises keypad interface 81, LCD control 82, and via multiplexer 94 and electronic read/write key reader 28. Shown in the description of the preferred embodiment of the disclosed systems is an electronic read/write key reader. Not shown but equally applicable, but not limited to, are magnetic card readers, RF/ID tag readers, barcode readers, Wiegand card readers, and contact tag readers. The aforementioned readers are accessed by microprocessor 87 via multiplexer 94 and serial port 90.

The peripheral equipment interface circuitry comprises satellite FMU interface 114, receipt printer interface 113, tank level monitor interface 112, on-site printer interface 111, level converters 105-108 and serial ports 94-97.

The remote communications interface comprises Modem 100 and LAN 80.

The program logic comprises data memory 84, program memory 86, reset control 78, oscillator 79, powerfail detect 77, clock and configuration memory 85, battery 76, and programming interface 109 with an associated level converter 93 and serial port 88.

In operation, FMU 24 receives RF data from AIM 21 via data antennas 73& 74, data transceiver 75 and serial port 83. The received data is stored in data memory 84 and portions of the received data are compared with authorization data also stored in data memory 84. Upon successful verification that the fueling site signature, the vehicle ID, the RF/ID Tag ID and the fuel type of the received data matches the authorization data and the hose is available, Microprocessor/microcontroller 87 allows the fuel dispensing hose matching the RF/ID Tag ID to dispense fuel.

The process to allow the hose matching the RF/ID Tag ID to dispense fuel is as follows. Microprocessor/microcontroller 87 programs a maximum pulse count which matches the fuel quantity limit for the vehicle so that the transaction is terminated upon reaching the fuel quantity limit. Microprocessor/microcontroller 87 activates a relay equating to the hose selected via relay select 98 and relays 102, and monitors the position of the selected pump handle via pump handle detect 103, multiplexer 101 and level converter 99. Microprocessor/microcontroller 87 commences counting pulses from the selected hose's pulser via the counters 89, level converter 92 and pulser interface 110 (the selected hose being the hose equating to the RF/ID Tag ID), and monitors the pulses for fueling rate. If the pump handle is turned off, and/or the pulse rate drops to zero for a programmable amount of time, and/or the programmed maximum pulse count is reached, and/or a message is received from the AIM indicating the hose has been removed from the filler neck, the fueling sequence completes and Microprocessor/microcontroller 87 terminates the fueling sequence by turning off the relay associated with the selected hose via relay select 98 and relays 102. Microprocessor/microcontroller 87 records the fueling sequence as a transaction in data memory 84. The fueling transaction includes at least the vehicle ID, current vehicle mileage and/or hours, fuel quantity, time and date and fuel type.

The disclosed system includes an optional fuel accounting system based on an electronic read/write key activated system whereby the user and/or each vehicle is issued the electronic read/write key, and with the electronic read/write key, a user has access to fuel. These electronic read/write keys have the necessary coded data, for example, to define vehicle/user ID, key number, allowable fuel types and quantity limits, vehicle mileage, mileage reasonability checks, and preventative maintenance flags. This optional fuel accounting scenario provides a system with all necessary security, control and accounting requirements for an unmanned fueling facility. As such, the present invention's operator interface comprises keypad interface 81, LCD control 82, and electronic read/write key reader 28.

Microprocessor/microcontroller 87 accesses read/write key reader 28 via serial port 90. The optional interface and operating firmware and software allow the disclosed system to operate with electronic read/write keys and/or with automotive information module equipped vehicles. As per a prior description of disclosed system microprocessor 87 via multiplexer 94 and serial port 90 are equally capable of but not limited to accessing magnetic card readers, RF/ID tag readers, barcode readers, Wiegand card readers, and contact tag readers.

FMU 24 is configured to provide an interface with peripheral items. The peripheral items include satellite FMU interface 114, receipt printer interface 113, tank level monitor interface 112 and on-site printer interface 111. The peripheral items are controlled by microcontroller 87 via serial ports 94-97 and level converters 105-108. These features allow users to receive a receipt for an individual transaction, the station operators to receive a complete print-out of all transactions and system functions, and the remote software operators to receive reports from tank level monitors via their normal interface with FMU 24. The normal interface between FMU 24 and the remote software, which usually is on an IBM compatible pc computer, is via modem or a LAN. The tank level monitor reports are in addition to all fuel accounting and invoicing functions offered in the software package. The normal interface is accomplished by FMU 24 via modem 100 or LAN 80.

FMU 24 has the provisions to communicate with satellite FMUs via RS422 serial communications. The satellite FMUs do not necessarily comprise tank level monitor interface 112, on-site printer interface 111, modem 100 or LAN 80. These features are usually accomplished by FMU 24. When FMU 24 is configured for communications with the satellite FMUs, FMU 24 is referred to as the “master FMU”.

Communications with FMU 24 can be accomplished via modem 100, LAN 80 or programming interface 109. The normal communications methods employed by the operators of the remote accounting and invoicing program are via modem 100 or LAN 80. FMU 24 can be accessed via programming interface 109 with associated level converter 93 and serial port 88, to allow on-site trouble shooting of FMU 24 via an external computer such as a PC laptop or a notebook.

Upon application of power, FMU's 24 power supply 115 monitors the line voltage to ensure that it is within prescribed limits and that the voltage is stable within the limits. Upon meeting the prescribed limits, voltage is then passed on to FMU 24. Upon receiving power, Microprocessor/microcontroller 87 completes an initialization process. The initialization process, as with FMU's 24 operational code, is read from program memory 86, and clock and configuration memory 85. If the line voltage becomes unstable, powerfail detect 77 issues a signal to Microprocessor/microcontroller 87 and Microprocessor/microcontroller 87 terminates any fueling transactions, stores the transactions in data memory 84, and awaits the re-application of power by power supply 115. Upon reapplication of power Microprocessor/microcontroller 87 will read the pertinent data relating to transactions that were in progress during the prior shutdown, complete the transaction data and store same in Data Memory 84.

The foregoing description of the preferred embodiment of the disclosed system has been presented to illustrate the principles of the disclosed system and not to limit the disclosed system to the particular embodiment illustrated. It is intended that the scope of the disclosed system be defined by all of the embodiments encompassed within the following claims and their equivalents.

We claim:

1. An automotive data control, acquisition and transfer system comprising:
an RF/ID tag mounted to a fuel nozzle;
an autonomous microprocessor/microcontroller controlled automotive information module (AIM);
an autonomous microprocessor/microcontroller controlled remote R/F communication system; and
a local or remotely located control and data transfer software program.

2. The automotive data control, acquisition and transfer system of claim 1, wherein said AIM includes:
a means for interrogating said RF/ID tag;
a means for accessing a vehicle's on-board computer data; and
a means for providing fueling security data to the remote R/F communication system and to said control and data transfer software program.

3. The automotive data control, acquisition and transfer system of claim 1, wherein said remote R/F communication system includes:
a fuel island mounted fuel management unit (FMU), which is in RF communication said AIM;
a communication and control means for communication and controlling multiple fuel dispensers; and
a communication means for communicating with said control and data transfer software program.

4. The automotive data control, acquisition and transfer system of claim 1, wherein said control and data transfer software program includes:
a means for communicating with said remote R/F communication system; and
a means for creating, maintaining, and disbursing information associated with the automotive data control, acquisition and transfer system.

5. The automotive data control, acquisition and transfer system of claim 2, wherein said means for accessing a vehicle's on-board computer data is an onboard diagnostic bus (OBD bus) port.

6. The automotive data control, acquisition and transfer system of claim 2, wherein said AIM further includes a means for receiving, linking, and communicating global positioning information.

7. The automotive data control, acquisition and transfer system of claim 2, wherein said AIM further includes a diagnostic means for providing diagnostic information for the AIM.

8. The automotive data control, acquisition and transfer system of claim 3, wherein said remote R/F communication system further includes a diagnostic means for providing diagnostic information for remote R/F communication system.

9. The automotive data control, acquisition and transfer system of claim 3, wherein said remote R/F communication system further includes an interface means for interfacing with commercial networks.

10. The automotive data control, acquisition and transfer system of claim 2, wherein said AIM further includes an interface means for interfacing with commercial networks.

11. The automotive data control, acquisition and transfer system of claim 1, wherein said control and data transfer software program includes storage means for storing information associated with the automotive data control, acquisition, and transfer system.

12. The automotive data control, acquisition and transfer system of claim 11, wherein said storage means for storing information associated with the automotive data control, acquisition, and transfer system is a database.

13. The automotive data control, acquisition and transfer system of claim 1, further comprising display means for displaying information associated with the automotive data control, acquisition and transfer system.

14. A method for automotive data control, acquisition and transfer, comprising:
obtaining fuel data from an RF/ID tag located on a fuel nozzle;
obtaining vehicle data from the vehicle's onboard computers;
transmitting data to a remote R/F communication system;
analyzing the fuel data and the vehicle data;
authorizing a fuel transaction; and
storing fuel transaction data.

15. The method for automotive data control, acquisition and transfer of claim 14 further comprising communicating with a global communication system.

16. The method for automotive data control, acquisition and transfer of claim 14 further comprising displaying information associated with the automotive data control, acquisition and transfer method.

17. The method for automotive data control, acquisition and transfer of claim 14, wherein said obtaining vehicle data from the vehicle's onboard computers utilizes an autonomous microprocessor/microcontroller controlled automotive information module (AIM).

18. The method for automotive data control, acquisition and transfer of claim 17, wherein said AIM includes:
a means for interrogating the RF/ID tag;
a means for accessing the vehicle's on-board computer data; and
a means for providing fueling security data to the remote R/F communication system and to said control and data transfer software program.

19. The method for automotive data control, acquisition and transfer of claim 17, wherein the remote R/F communication system includes:
a fuel island mounted fuel management unit (FMU), which is in RF communication said AIM;
a communication and control means for communication and controlling multiple fuel dispensers; and
a communication means for communicating with said control and data transfer software program.

20. The method for automotive data control, acquisition and transfer of claim 14, wherein said storing fuel transaction data uses a local or remotely located control and data transfer software program.
